(19) United States
(12) Patent Application Publication
(10) Pub. No.: US 2012/0151450 A1
(43) Pub. Date: Jun. 14, 2012

(54) Platform-Agnostic Diagnostic Data Collection and Display

(75) Inventors: Matthew Saffer, Seattle, WA (US); Leonid Dubinsky, Redmond, WA (US)

(73) Assignee: MICROSOFT CORPORATION, Redmond, WA (US)

(21) Appl. No.: 12/963,630

(22) Filed: Dec. 9, 2010

(51) Int. Cl. G06F 9/44

(52) U.S. Cl. 717/128; 717/130

(57) ABSTRACT

A data collection system may instrument and collect data from arbitrary executable code by loading the executable code into memory and instrumenting the code according to monitoring conditions. The instrumentation may include pointers or bindings to a data collector that may gather and store information when the monitoring condition exists. A display module may allow a programmer to browse the results. The data collection system may operate on any type of native code or intermediate code and may operate with or without symbol tables.

### BACKGROUND

Debugging programming code can be a difficult task in the best of conditions. Often, code may be written by different developers, each of which may have a different programming style or set of conventions. The problem can magnify when code comes from different sources, such as different vendors, or when code is written and enhanced over many years.

In many programming environments, a debugging suite may allow a user to edit and debug code in an effective manner. Generally, such environments may display the variable names, values, and other information in a human readable form. However, this may use the source code and symbol tables to create a useable and efficient debugging system. Such environments may not operate well with code for which the source code may not be available.

### SUMMARY

A data collection system may instrument and collect data from arbitrary executable code by monitoring the code according to predefined monitoring conditions. The instrumentation may include pointers or bindings to a data collector that may gather and store information when the monitoring condition exists. A display module may allow a programmer to browse the results. The data collection system may operate on any type of native code or intermediate code and may operate with or without symbol tables.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a data collection system for executable code.

FIG. 2 is a flowchart illustration of an embodiment showing a method for preparing to monitor an executable code.

FIG. 3 is a flowchart illustration of an embodiment showing a method for capturing data for an executable code.

### DETAILED DESCRIPTION

A data collection system may monitor any type of executable code for use in debugging and other operations. The executable code may be loaded into a computer memory and various conditions within the code may be identified. At each condition, the executable code may be instrumented with a call to a collection routine. The collection routine may identify various objects to gather, which may be stored by a storage routine. Once the data are collected, a visualization system may view the data for debugging and other purposes.

The data collection system may be capable of gathering complex data types, which may be serialized prior to storage and deserialized prior to viewing. The data collection system may be capable of collecting data from any type of executable code, whether or not source code and symbol tables may be available. Such a capability may allow arbitrary executable code to be incorporated into a debugging operation.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, microcode, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

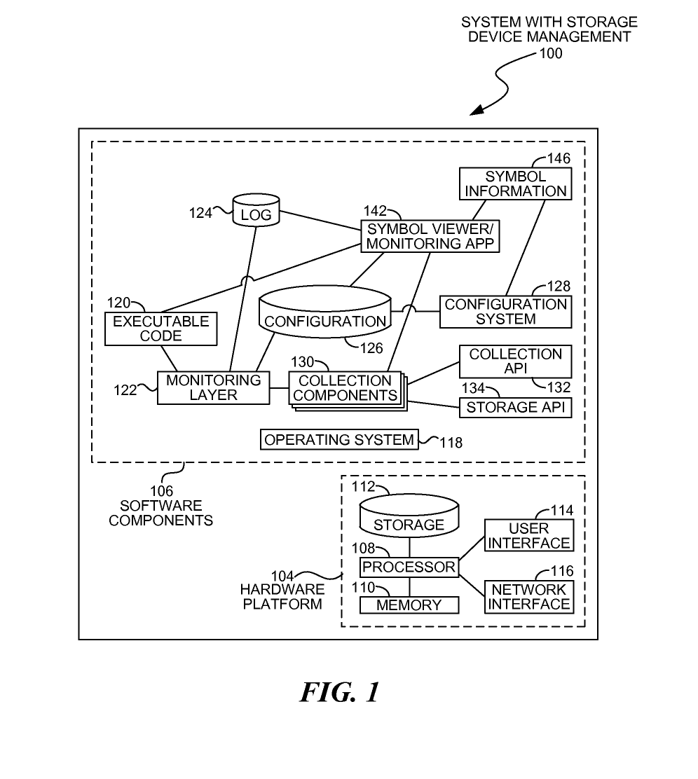

FIG. 1 is a diagram of an embodiment 100, showing a system that may include a data collection system for executable code. Embodiment 100 is a simplified example of a hardware and software platform that may execute arbitrary executable code and monitor certain conditions within the executable code.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates a computer system that may instrument an arbitrary executable code for debugging purposes. Various conditions may be defined that may be used to identify places within the executable code where a collection routine may be called. The collection routine may locate various data types within the executable code and cause the data types to be stored.

The data collection system may operate on a device 102. The device 102 is illustrated having hardware components 104 and software components 106. The controller device 102 as illustrated represents a conventional computing device, although other embodiments may have different configurations, architectures, or components.

In many embodiments, the controller device 102 may be a personal computer or code development workstation. The controller device 102 may also be a server computer, desktop computer, or comparable device. In some embodiments, the controller device 102 may still also be a laptop computer, netbook computer, tablet or slate computer, wireless handset, cellular telephone, or any other type of computing device.

The hardware components 104 may include a processor 108, random access memory 110, and nonvolatile storage 112. The hardware components 104 may also include a user interface 114 and network interface 116. The processor 108 may be made up of several processors or processor cores in some embodiments. The random access memory 110 may be memory that may be readily accessible to and addressable by the processor 108. The nonvolatile storage 112 may be storage that persists after the device 102 is shut down. The nonvolatile storage 112 may be any type of storage device, including hard disk, solid state memory devices, magnetic tape, optical storage, or other type of storage. The nonvolatile storage 112 may be read only or read/write capable.

The user interface 114 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 116 may be any type of connection to another computer. In many embodiments, the network interface 116 may be a wired Ethernet connection. Other embodiments may include wired or wireless connections over various communication protocols.

The software components 106 may include an operating system 118 on which various applications and services may operate. An operating system may provide an abstraction layer between executing routines and the hardware components 104, and may include various routines and functions that communicate directly with various hardware components.

Embodiment 100 illustrates a software architecture that may be used to collect and store data based on several conditions in executable code. In an example architecture, some executable code 120 may execute with a monitoring layer 122. The monitoring layer 122 may populate a log 124 that may be read using a log viewer 136. The monitoring layer 122 may interact with various collection components 130 that may define data to be collected when certain conditions may be met during execution.

The collection components 130 may have a collection API 132 and a storage API 134. The collection API 132 may include various predefined routines that may gather data and may be called from the collection components 130. The collection API 132 may include functions to gather data from different sources.

For example, one programming environment or language may store a data type using one format while another programming environment or language may store the same data type in a different format. The collection API 132 may have collection routines that gather data in the format in which it was stored, then the storage API 134 may convert that data into a common format for storage and retrieval.

The storage API 134 may serialize complex data types prior to storage. In many embodiments, the storage API 134 may store the data and metadata that may be used to inflate or reconstitute the data types for viewing or other purposes.

In many embodiments, the collection components 130 may be individual routines, statements, or other mechanisms to define what may be collected when a condition may be encountered. The collection components 130 may be written by a developer who may be performing debugging on the executable code 120.

The data collection system may provide many of the tools for a developer to instrument compiled executable code and to monitor, collect, and view objects when the executable code executes. In order to monitor any type of executable code, the developer may define the conditions at which data collection may occur, then define the data to collect. The data collection system may monitor the executable code for the condition, then call an appropriate routine from the collection API 132 to collect the identified data, then call a storage routine from the storage API 134.

The data collection system may allow extensive instrumentation and monitoring to be added to previously compiled executables. The data collection system may be useful when the source code used to create the executables may not be available. Because the instrumentation and monitoring may occur after compiling, the executable code may not be changed prior to monitoring.

In some embodiments, a data collection system may be capable of monitoring code that came from different sources. For example, an older legacy application programming interface may operate with a newly developed application. The legacy application programming interface (API) may have come from a manufacturer and the developer may not have any source code. The newly developed application may be written in a newer programming language, and both the API and the application may interact during execution. A developer may instrument both the API and application using the data collection system to collect, display, and review debugging information.

The collection components 130 may define data to be collected from multiple sources when a monitored condition may be encountered. In the example above, a collection component may define information to collect from the API as well as the application. Because the collected data may be in different formats within the API and application, the collection API 132 may convert both data formats into a common data format for consumption by the storage API 134.

A configuration 126 may define when the data are to be collected. The configuration 126 may contain expressions that define conditions on which data may be collected, as well as the specific collection component 130 that may be called when the condition is met. A configuration system 128 may be an interactive application for creating the various conditions for data collection.

In some embodiments, the conditions defined in the configuration 126 may be complex expressions that may include multiple inputs, wild cards, algebraic expressions, or other components. The conditions may include references at an assembly or dynamic linked library level, type or interface level, or at a method level. Using the various expressions and levels of conditions, a developer may be able to create a very wide range of conditions at which data collection may be performed.

At an assembly or dynamic linked library level, a condition may include various references to assemblies or dynamic linked libraries of certain names, having public key tokens, versions of the libraries, culture associated with the libraries, various attributes of the libraries, names of modules within the libraries, and other parameters. In a simple example, a condition may be defined to capture data whenever an assembly may be accessed that begins with the letter ‘A’. Another example may be to define a condition to capture data when a specific version and culture of a specific library is accessed.

At a type or interface level, conditions may be defined based on type or interface name, various metadata about the type or interface, any interfaces implemented by a type, visibility parameters, attributes of the type of interface, pointers to specific assemblies, or other parameters.

At the method level, conditions may be defined based on a method name, metadata concerning the method, arguments passed to the method, return values from the method, explicit interface implementations, various attributes of the method, visibility settings, or other parameters.

The executable code 120 may or may not have separate symbol information. In some programming environments, the executable code 120 may have metadata that may be used by a just-in-type compiler or other runtime component to convert the executable code 120 into machine language that may be linked to various assemblies or dynamic linked libraries at runtime. In such embodiments, symbol information may be directly read or derived from the executable code 120.

In embodiments where the symbol information may not be incorporated into the executable code 120, symbol information may be derived from the executable code. Such a derivation may be performed using various reflection techniques or routines which may analyze the executable code 120 and create a symbol table that may include names of various programming objects, such as methods, types, interfaces, assemblies, parameters, variables, or other artifacts within the executable code. In some embodiments, a symbol table may be provided with the executable code 120 as a separate file.

The symbol information 146 may include any type of symbol information for the executable code 120. Naming and labeling information within the symbol information 146 may be used within the configuration system 128 to identify objects within the executable code 120 using human readable and sometimes meaningful labels for the objects. The symbol information 146 may include metadata describing the data types that may assist a developer to create conditions when using the configuration system 128.

A symbol viewer and monitoring application 142 may be a central user interface through which a developer may create the configuration 126 containing conditions for monitoring, along with defining collection components 130 and viewing the log 124.

The application 142 may receive the executable code 120 and determine any type of symbol information 146 that may be included in the executable code 120. In some cases, the application 142 may perform a reflection on or analyze metadata within the executable code 120. In other cases, the application 142 may receive a symbol table or other secondary source of symbol information.

The application 142 may have a graphical user interface or other mechanism by which a developer may browse the symbol information 146 to locate objects within the executable code 120 to create conditions. In many embodiments, the application 142 may allow the developer to create complex expressions for the conditions.

A developer may then us the application 142 to create various collection components 130. The developer may define the data to be collected by viewing the symbol information 146. In some embodiments, the developer may be able to define filters or limits on the data to be collected which may also be defined in the collection components 130.

After causing the executable code 120 to be executed with the monitoring layer 122, the application 142 may be able to display the collected data from the log 124. When symbol information 146 is available, the application 142 may present the data from the log 124 in a high fidelity fashion. The high fidelity fashion may include labeling, formatting, and organization of the data types in the display.

The executable code 120 is illustrated as a single component. In some embodiments, the executable code 120 may be multiple components, each of which may be written in a different language using different data storage mechanisms and having other different characteristics. The application 142 may enable a developer to create a single set of collection components 130 that may call the collection API 132 to gather complex data types from each of the portions of executable code, serialize those data types into a common log 124. The application 142 may retrieve the data from the log 124 and present the data in a consolidated view.

Because the data collection system may use a standardized storage API 134, data may be collected and consolidated from executable code from multiple sources but displayed in a unified or consolidated view.

In some embodiments, the functions of the application 142 may be incorporated into a graphical code development platform. Such a system may have a code editor and various compiling and debugging functions for creating new code, as well as a data collection system that may gather data from other executable code that may interact with the new code being developed.

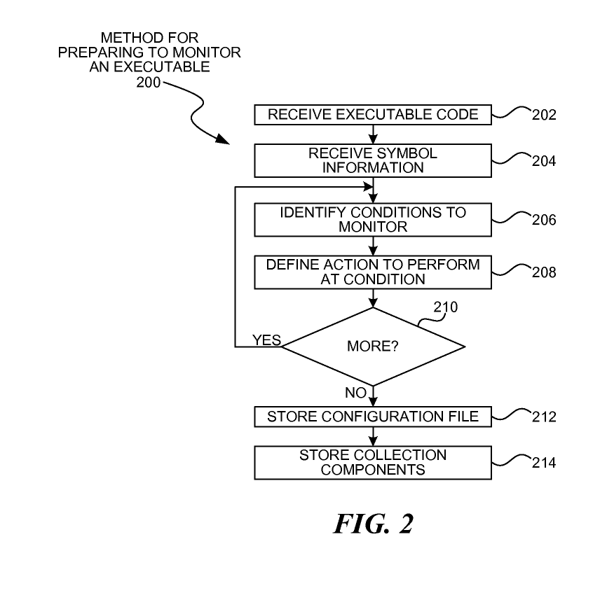

FIG. 2 is a flowchart illustration of an embodiment 200 showing a method for preparing to monitor an executable. The process of embodiment 200 is a simplified example of how conditions may be created that identify when a data collection event may occur.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The executable code may be received in block 202, as well as the symbol information in block 204. In some embodiments, the symbol information of block 204 may be derived from the executable code, either by analyzing metadata within the code or by performing a reflection. In some cases, the symbol information may be supplied in the form of a symbol table or other database.

In block 206, a developer may identify conditions to monitor. The conditions may be defined using objects defined in the symbol information. For example, a method may be defined by the label from the symbol information. A monitoring layer may receive the symbol information in the condition and convert the symbol condition to a memory location to monitor the condition.

In block 208, the developer may identify actions to be performed when the condition occurs. The actions may be defined in the collection components as discussed in item 130 of embodiment 100. Similar to the conditions, the actions may be defined using symbol information. The symbol information may be converted into memory locations or other machine-level information to identify the desired data to be collected. The action defined in block 208 may be associated with the condition defined in block 206.

The process of creating conditions and actions may loop back to block 206 from block 210. When all of the conditions and actions are defined in block 210, a configuration file may be stored in block 212 as well as the collection components in block 214. The configuration file of block 212 may be consumed by a monitoring layer that may execute with the executable code to identify conditions, then cause the collection components to be executed.

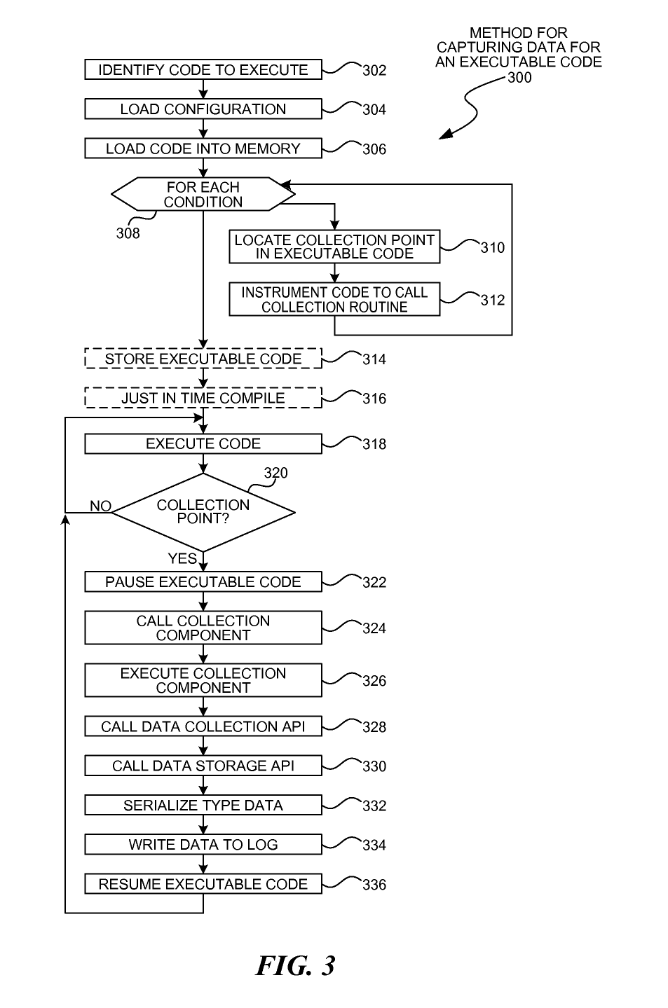

FIG. 3 is a flowchart illustration of an embodiment 300 showing a method for capturing data for an executable code. The process of embodiment 300 is a simplified example of a process for monitoring an executable code, identifying a condition, then executing a collection component to collect data and storing the data.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may be an example of the runtime operations that may be performed when monitoring an executing application. The operations of embodiment 300 may be performed by a monitoring layer, collection components, and various APIs.

The operations of embodiment 300 illustrate a method where the executable code may be instrumented with calls to collection components. In other embodiments, a monitoring layer may operate in parallel with the executable code to identify conditions without instrumenting the executable code.

In block 302, the code to execute may be identified. The configuration information may be loaded in block 304. The executable code may be loaded into memory in block 306.

For each condition in block 308, the point within the executable code where the condition may occur may be identified in block 310. The code may be instrumented at that point in block 312 to call the corresponding collection routine.

After processing each condition in block 308, the executable code may be stored in block 314.

In some embodiments, some or a portion of the executable code may be compiled using a just in time compiler in block 316.

The code may begin executing in block 318. The code may execute until one of the conditions may be identified in block 320 as a data collection point.

In some embodiments, the executable code may be instrumented with a function call to a collection routine. In other embodiments, a monitoring layer may track changes in the executing process to identify conditions for collecting data.

When a collection point is identified in block 320, the executable code may be paused in block 322. In embodiments where the executable code may be instrumented with function calls, the executable code may pause while the function call is being performed, and may resume after the function call has completed operations.

In some embodiments, the executable code may not be paused. An example may be in the case of an executable that is not instrumented but may be monitored by a monitoring layer. In such embodiments, it may or may not be possible to pause the application.

The collection component may be called in block 324 and executed in block 326. The collection component may define what data are collected, and may pass a request and various parameters to a data collection API in block 328 to gather the requested data. In some embodiments, the collection component may pass several requests to the data collection API and receive several responses. In some such embodiments, the collection components may collect data from different pieces of executable code with different data type definitions and storage mechanisms.

In block 330, the collected data may be passed to a data storage API, which may serialize and store the data in a common format. In many embodiments, the data may be collected from two or more different sources, each having a different data storage format, and the collected data may be stored in a common format that may or may not correspond with one of the formats of the data sources.

The storage API may serialize the data in block 332 and write the data to a log in block 334.

If the executable code was paused in block 322, the executable code may be resumed in block 336 and the process may return to block 318 to continue execution.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving executable code;
receiving configuration defining a condition to monitor in said executable code;
identifying at least one location within said executable code according to said condition;
instrumenting said executable code at said at least one location, said instrumenting comprising a call to a collection routine;
executing said executable code until said condition exists; and
when said condition exists, cause said collection routine to be executed.

2. The method of claim 1, said executable code being received into random access memory prior to said instrumenting.

3. The method of claim 1, further comprising:
pausing at least a part of said executable code when said condition exists; and
resuming said executable code after said collection routine has been executed.

4. The method of claim 1 further comprising:
receiving symbol information for said executable code; and
using said symbol information for said identifying at least one location within said executable code.

5. The method of claim 4, said symbol information being obtained by reflection of said executable code.

6. The method of claim 1, said executable code being intermediate code.

7. The method of claim 1, said executable code being native code.

8. The method of claim 7, said native code having no symbol information.

9. The method of claim 1, said collection routine collecting data associated with said executable code.

10. The method of claim 1, said collection routine retrieving a type associated with said executable code, serializing said type to create a serialized type, and storing said serialized type in a log file.

11. The method of claim 1, said collection routine collecting data not associated with said executable code.

12. A system comprising:
a processor;
a configuration system that:
reads symbol information for an executable code;
receives a condition for collection; and stores said condition;
a runtime executor that:
receives said executable code;
monitors said executable code according to said condition;
executes said executable code; and
identifies said condition for collection and launches a collection routine;
a collector that:
executes said collector routine;
finds data defined in said condition; and
stores said data.

13. The system of claim 12 further comprising:
a log viewer that displays said data.

14. The system of claim 13 that uses said symbol information when displaying said data.

15. The system of claim 14, said symbol information being derived from a reflection of said executable code.

16. The system of claim 14, said executable code being intermediate code.

17. A system comprising:
a processor;
a configuration system that:
receives a condition for collection, said condition comprising a method call in an executable code; and
stores said condition;
a runtime executor that:
receives said executable code;
loads said executable code into memory accessible to said processor for executing said executable code;
instruments said executable code according to said condition by adding a pointer in said executable code;
executes said executable code; and
launches a collection routine when said pointer is encountered during said execution;
a collector that:
executes said collector routine;
finds data defined in said condition; and
stores said data.

18. The system of claim 17, said runtime executor that further:
pauses said executable code when said pointer is encountered.

19. The system of claim 18, said configuration system that further:
performs a reflection on said executable code to generate a symbol table; and
uses said symbol table to identify said condition.

20. The system of claim 19 further comprising:
a log viewer that:
receives said data; and
presents said data using said symbol table.
